(19) United States
(12) Patent Application Publication
(10) Pub. No.: US 2007/0181620 A1
(43) Pub. Date: Aug. 9, 2007

(54) Ring system for securing devices

(76) Inventor: William Hampton Carver III, Richmond, VA (US)

Correspondence Address: J. Michael Martinez de Andino, Esq.;HUNTON & WILLIAMS LLP, Riverfront Plaza, East Tower, 951 E. Byrd Street, Richmond, VA, 23219-4074, US

(21) Appl. No.: 11/351,032

(22) Filed: Feb. 9, 2006

(51) Int. Cl. A61C 19/00; A41D 19/00

(52) U.S. Cl. 224/217; 224/901

(57) ABSTRACT

A ring system that when worn by the user and attached to handheld devices, enhances the security, control and use of such devices. The ring system includes a conical ring element, a receiver, a connector, a terminal end and an anchor pad. One or more of these elements may be an integral member of the ring system depending on the method of manufacture. The ring element may be attached to the device via a receiver, a connector, a terminal end and an anchor pad. The anchor pad is attached to the back of the handheld device and the terminal end of the connector is attached to the anchor pad by means of connection. The conical ring element may be worn on the user's finger in variable positions. Thus utilized, the ring system places the handheld device in close proximity to the user's fingers and palm enhancing control, security and manipulation of the device.

### BACKGROUND OF THE INVENTION

The present invention relates generally to methods for optimizing use of hand held devices, and more particularly to a ring system comprising a conical shaped ring to be worn on one's finger and bearing a connector that can be attached to handheld devices such as a PDA, camera, MP3, game, cell phone, walkie/talkie, GPS, etc. Thus, the ring system provides a more dexterous use of the device resulting in optimized function, convenience, and security.

The invention is an innovation in securing handheld devices. The invention also secures any item that the user wishes to maintain securely close at hand. If a device fits in your hand, then use of the invention will optimize function, convenience, comfort and security. While many handheld devices are used with lanyards or straps which can provide some security against accidental dropping of the device, such methods do not provide the user with improved function or use of the device itself, nor are they intended to do so.

The invention's primary function is to aid in securely carrying a handheld device. However, the invention's unique design optimizes the use and function of handheld devices. The invention accomplishes this by maintaining the device in close proximity to the user's hand and within the immediate grasp of the user's fingers. The invention's design and resilient characteristics provide the user with the mobility required to manipulate and use the device, while maintaining control and secure possession.

As the public becomes more dependent on handheld devices such as personal music players, cell phones, and PDAs, etc., these devices are often needed securely close at hand. Whether it be for communicating, appointment scheduling, or for listening entertainment, these devices must be manipulated (opening, scrolling, dialing, typing, writing, etc.) by the user for proper function and this manipulation is the usual cause for faulty selections or data entry, loss of control and the resulting damage to the device by dropping, or loss. For example, telephones may accidentally slip out of a pocket and fall into a body of water such as a toilet. Some phone companies are placing special films inside of the telephones, and these films will change color when immersed in water. For example, if the special film turns red, then the phone company may refuse to freely replace the telephone because the special film indicates immersion.

As these handheld devices become more stylish and more important cultural statements and fashion accessories, users will wish to have them available for public view, although with a sense of security. For example, the iPod™ may be used by a teenager as a fashion statement. Further, the continuing miniaturization of electronics has created devices that are smaller than a deck of playing cards, and objects of this small size are ideally suited for attachment to a finger.

For these reasons and others, such devices when in use will most often be held in the hand, and are described as “hand held devices”. This tendency and developing trends require new methods of providing security, dexterity, function and convenience of use. It is with this in mind that the present invention is created.

### SUMMARY OF THE INVENTION

The present invention provides an apparatus and method for securing handheld devices and other items to the hand via a ring system. In one preferred embodiment, the ring system may comprise the following elements attached in the following order: a ring element, a receiver, a connector, a terminal end, and an anchor.

The ring element fits around the user's finger. The ring element is attached to the receiver. The receiver is attached to the connector. The connector is attached to the terminal end. The terminal end is attached to an anchor. In another preferred embodiment each of these elements may be integral parts of the ring system.

Various elements may be omitted or rearranged. For example, the anchor may be omitted when the handheld device (such as a camera) has an integral anchor (for example, a through-hole for attaching lanyards, or a threaded blind hole for attaching a tripod). In this embodiment, the terminal end of the invention may be adapted to attach to said integral anchor.

Alternately, the ring element may be directly attached to an anchor, omitting the connector. In this embodiment, the handheld device would be very closely linked to the finger, almost like a large ring. For example, a small telephone may be worn as a ring on the outside of the hand while driving, and then may be rotated about the finger to the inside of the hand in order to speak on the phone.

In another embodiment, two ring elements may be directly linked to a single device such as a small phone, and the phone may be maintained on the outside of the hand while speaking on the phone. In this embodiment, the hand may be curled into a fist, and the phone (positioned externally like a large ring) may be placed near the ear. This embodiment would be particularly useful placed on the left hand, so that a right-handed user may dial a phone number with the right hand. Note that two ring elements linked directly to a single device (two attachment points) would stabilize the device by removing one degree of freedom of rotation. This stabilization may be preferred by some users for some devices. The two ring elements may be placed on separate fingers, or may be placed on a single finger.

In a preferred embodiment, the ring element comprises a truncated conical, annular, ring element. The ring element may be formed from a linear piece of resilient material that. The conical ring element provides a snug graduated fit caused by the compression of the resilient material as the user inserts his finger through the opening of the conical ring element.

This graduated fit enables the user to adopt varying positions on the user's finger, which enables the user to control the attached devise in varying positions within the user's hand enhancing the manipulation and security of the devise. The conical ring shape and resilient material of the invention facilitate safe and easy removal from the user's finger.

Additionally, the resulting variation in control of the device improves use through added dexterity, function and security. The characteristics of the invention include flexible sizing of the ring element allowing one conical ring element to fit a wide range of finger and hand sizes. This unique feature enables the user to comfortably and effectively wear the invention on different fingers and hands. This unique flexible sizing capability also provides greater flexibility in sizing as the combination of the conical shape and a resilient material will enable variable fit and sizing so that just a few categories of ring size (for example, small, medium, and large) can provide a comfortable fit for a very wide range of finger sizes, as opposed to current ring sizings required by rings made of rigid or non-resilient materials. Thus, a small number of models will serve the entire population.

The graduated fit also enables the user to select different levels of security and convenience. For quick or casual use the user can wear the ring system on the first or second segment of the finger and gain the convenience, dexterity and manipulative control provided by the invention. For longer term use, or for use while walking, jogging, or for active use in unstable environments such as boating or traversing uneven terrain, the user can wear the ring element on the segment closest to the hand. This will provide a highly secure fit providing ultimate control allowing active manipulation of the device and improved function during physical activity and in moving environments such as boating.

Varying colors materials and textures will be utilized in manufacturing the invention to provide multiple designs including those with jewelry features. The uniqueness of the design also creates promotional opportunities with the application of logos, etc.

### BRIEF DESCRIPTION OF THE FIGURES

The following description for the preferred embodiments to a ring system for handheld devices is merely exemplary in nature and is in no way intended to limit the invention or its application or uses.

The invention will be illustrated by reference to the following drawings:

FIG. 1 shows a preferred embodiment of a ring system comprising: ring element, receiver, connector, terminal end, anchor pad and double sided tape.

FIG. 2 shows a preferred embodiment of a ring element.

FIG. 3 shows a preferred embodiment of a receiver.

FIG. 4 shows a preferred embodiment of a connector.

FIG. 5 shows preferred embodiments of a terminal end.

FIG. 6 shows several embodiments of connectors and anchors.

FIG. 7 shows several embodiments of anchors.

FIG. 8 shows an embodiment of a ring element created from a single strip of fabric and joined to a receiver.

FIG. 9 shows an embodiment of a ring element with an internal element, and external shell, and with an integral external receiver.

FIG. 10 shows an embodiment of a ring element with an internal element, and external shell, and with an integral internal receiver.

FIG. 11 shows an embodiment comprising a rectangular flat strip formed into a ring element.

FIG. 12 shows more views of an embodiment comprising a rectangular flat strip formed into a ring element.

FIG. 13 shows a ring element with integral receiver, connector, and terminal end.

### DETAILED DESCRIPTION OF THE EMBODIMENTS

In one preferred embodiment, a ring system comprising: ring element, receiver, connector, terminal end, and anchor pad. The ring element may comprise a resilient material that is constructed to form a conical ring element by overlapping the two ends of the material and joining the two ends at approximately right angles by fusing with glue, heat, stitching, rivets grommets, etc. to create a conical ring shape with an annular opening passing through the conical ring element.

The conical ring element may be described geometrically as approximately a truncated cone with a hole or annulus passing through its axis. The hole or annulus is also approximately conical, with one end having a larger diameter than the other end.

The conical ring element may be constructed from a resilient material, and thus may expand as it is pulled over a finger to create a snug elastic fit, or a pressure fit. This fit will become more snug as the conical ring element is moved from the small diameter tip of a finger towards the larger diameter base of the finger (where the finger attaches to the palm of the hand). This graduated fit of the conical ring provides unique benefits including: variable fit and sizing, ambidextrous hand and finger selection, and variable distancing between the devise and the user's palm thereby regulating manipulative control of the devise and increased function and security.

The resilient material may form the entire ring element. Alternately, the resilient material may serve as an inner liner for a relatively rigid or nonresilient exterior shell. The resilient material liner together with the conical shape provides the graduated fit. When a rigid or non-resilient material is used for the outer shell of the ring element, then the resilient material inner liner provides the flexible fit created by the compression of the inner liner caused by insertion of the user's finger into the openings in ring element. The resilient quality of the inner liner material enables a rigid or non-resilient ring element to provide variable fit and sizing.

These embodiments are illustrated in the figures discussed below.

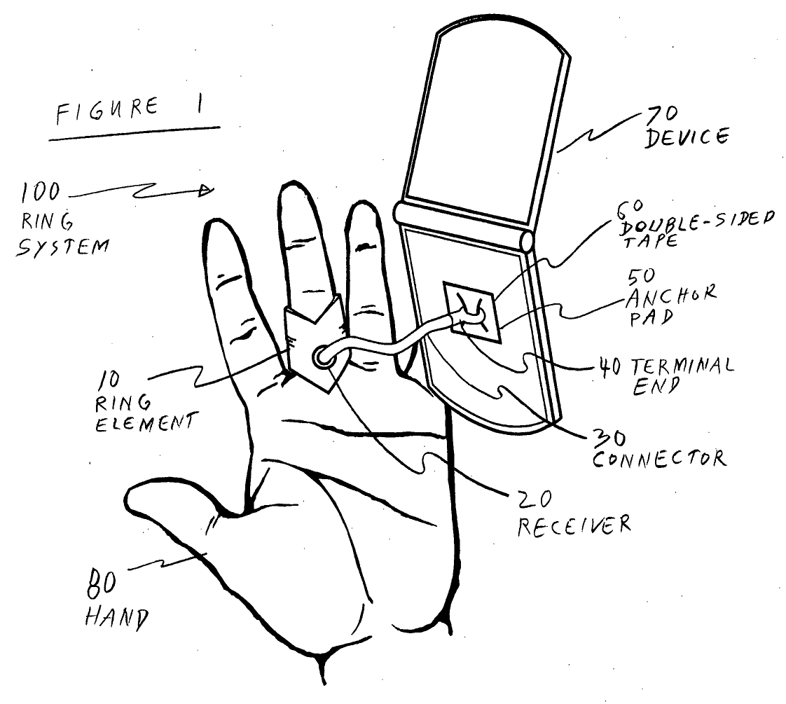

FIG. 1 shows one preferred embodiment of a ring system comprising: ring element, receiver, connector, terminal end, and anchor pad. Ring system 100 comprises ring element 10, receiver 20, connector 30, terminal end 40, and anchor pad 50. In some embodiments anchor pads and receivers may be interchangeable. The ring element 10 may be snugly secured about a finger or thumb of hand 80, and the anchor pad 50 may be attached by double sided tape 60 to a handheld device 70 such as a flip phone. Other handheld devices such as cameras, or audio equipment, or GPS devices, etc. are also contemplated.

The ring element 10 may be conically ring shaped, and may comprise a resilient material. The receiver 20 may be adapted to attach to the connector 30, and the connector 30 may be a link, loop, chain, cord or other connecting structures known in the art.

The connector 30 may be any convenient length, and may be omitted entirely. If the connector is omitted, then the ring element would attach directly to an anchor pad through a combination receiver/terminal element.

The terminal end 40 may be permanently attached to the anchor pad 50, or may be detachable and re-attachable with the anchor pad 50, or may be integrally formed into a single unit with the anchor pad 50.

Alternately, the terminal end 40 may have a hook or a lanyard or a bolt for connecting to a pre-existing attachment point on a device. For example, many cameras comprise an attachment point that is a hole through the chassis adapted to accept a lanyard. Other cameras comprise an attachment point that is a threaded blind hole adapted to accept a bolt from a tripod.

The anchor pad 50 may have a flat portion adapted to receive a first side of double-sided tape 60, wherein the second side of double sided tape 60 (or double sided foam) may be attached to a device. Other embodiments may include and anchor pad 50 with pre-applied adhesive that is exposed by removing a protective cover. Velcro may be used in place of double sided tape to temporarily attach the anchor pad 50 to the device 70, so that multiple devices may be used with a single ring system, or so that multiple ring systems may be used with a single device.

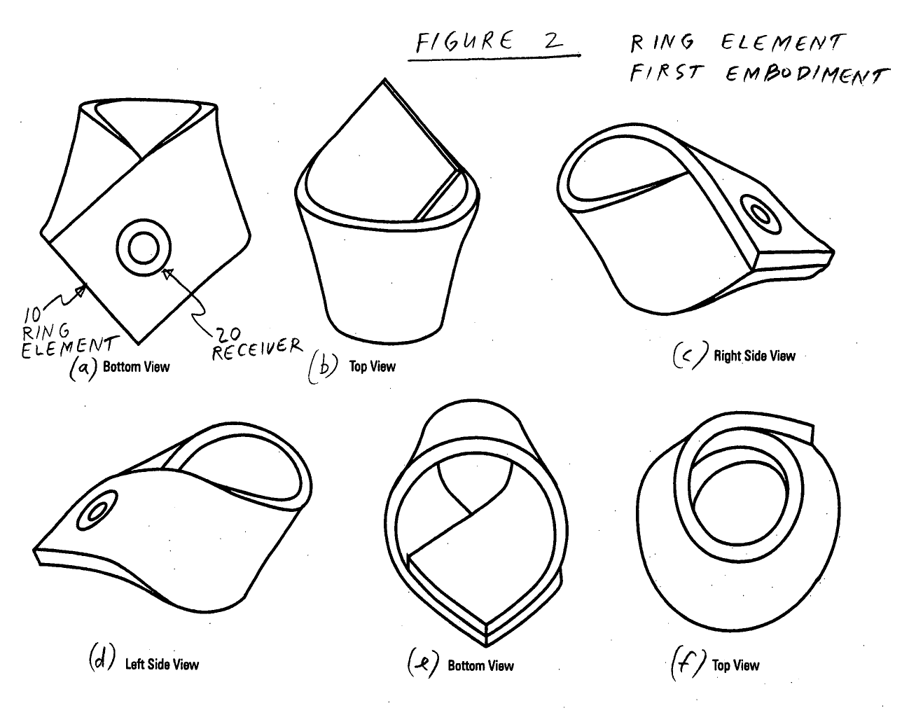

FIG. 2 shows an embodiment of a ring element. FIG. 2 shows a ring element 10 and a receiver 20. In this first embodiment of a ring element 10, the body of the ring element 10 is constructed from a flat rectangular strip of resilient material which has been positioned so that the ends overlap approximately perpendicularly, and then receiver 20 has been inserted to retain the orientation of the overlapped or folded flat rectangular strip. Ring element 10 is shown from various angles in views (a) through (f). The preferred conical shape of ring element 10 is clearly illustrated.

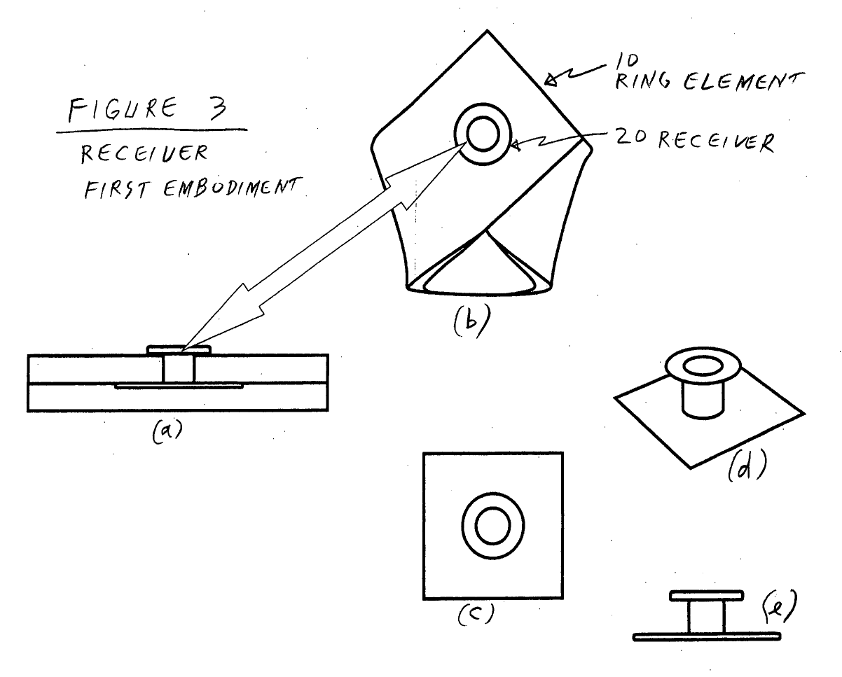

FIG. 3 shows an embodiment of a receiver. FIG. 3 shows a ring element 10 and a receiver 20. In this first embodiment of the receiver 20, the receiver 20 comprises an approximately rivet type shape and is constructed from a relatively stiff material. The receiver 20 may be glued, thermo-set, or mechanically set into position. View (a) shows a cross section of the receiver 20. The receiver 20 in this embodiment does not penetrate below the interior portion overlapping portions of the ring element. Alternately, the receiver 20 may penetrate both overlapping portions of the ring element and functionally act like a rivet to lock the overlapping portions into place relative to each other (keep them from rotating about the axis of the receiver). Views (b) through (e) provide alternate detailed views.

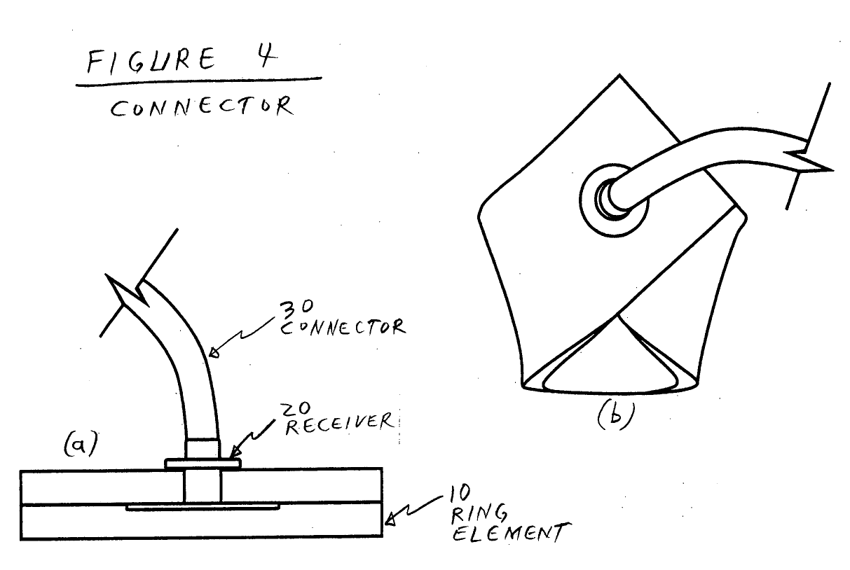

FIG. 4 shows an embodiment of a connector. FIG. 4 shows a connector 30 attached to receiver 20, which in turn is attached to ring element 10. The connector 30 may be be constructed from any flexible material such as cylindrically shaped silicone rubber, or braided nylon cord, or any other construction known in the art. The receiver 20 may attach to the connector 30 with glue, or the receiver 20 may be crimped over the connector 30, or the receiver 20 may be integrally constructed with connector 30 such that they are a single part, or the receiver 20 may be fused to the connector 30, or the receiver 20 may be joined with the connector 30 in other ways known in the art. Views (a) through (b) provide alternate detailed views.

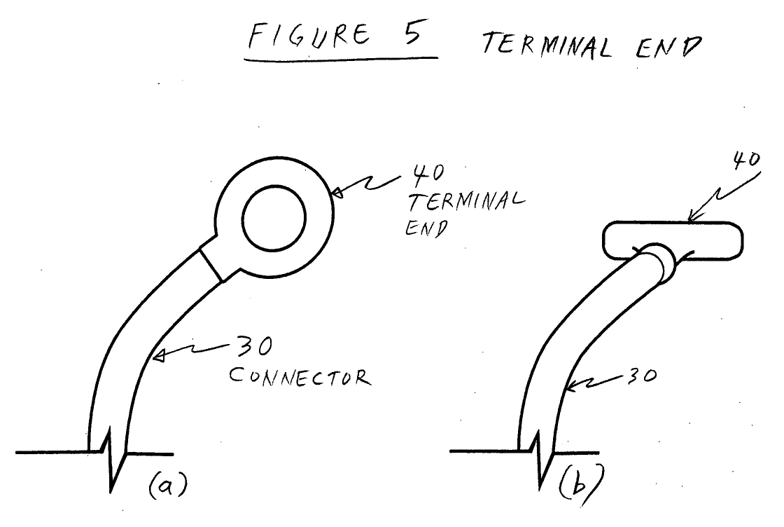

FIG. 5 shows embodiments of a terminal end. FIG. 5 view (a) shows a connector 30 attached to an eyelet shaped terminal end 40. Similar to the above discussion in FIG. 4, the connector 30 may be attached to terminal end 40 by many methods known in the art. FIG. 5 view (b) shows an alternate T-bar shape for the terminal end 40. The terminal end 40 may comprise a T-bar, circular connector, hook, loop, lobster claw, spring clip, snap or any other shape known in the art for attachment to an anchor or to a device.

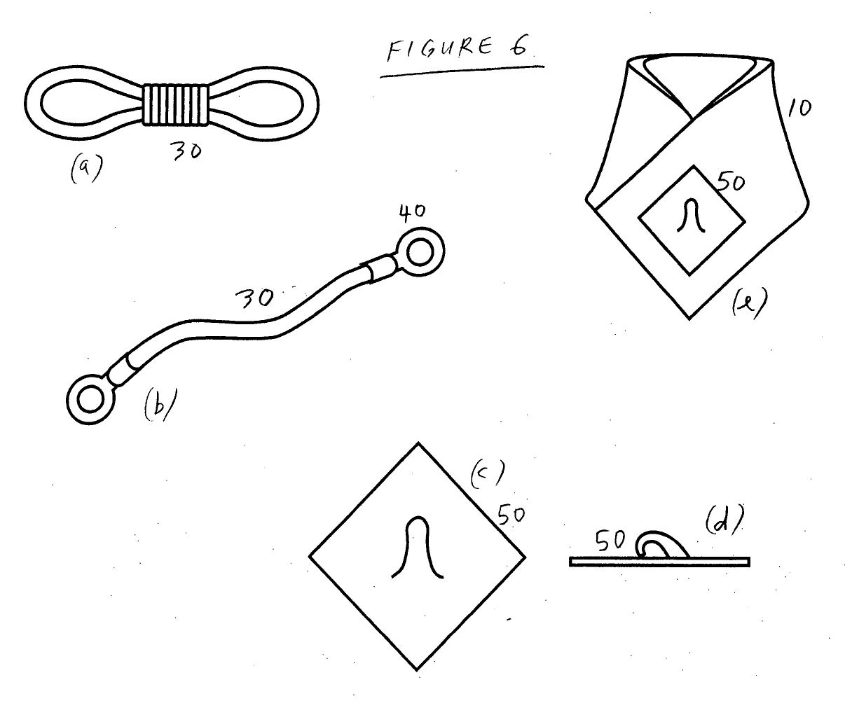

FIG. 6 shows several embodiments of connectors and terminal ends. FIG. 6 view (a) shows a double loop shaped connector, wherein one end may be crimped into a receiver, and then the second end may be crimped into a terminal end or looped into an anchor. View (b) shows a double ring shaped connector, wherein one end may be joined to a receiver, and then the second end may be defined as a terminal end and attached to an anchor. Views (c) and (d) are alternate views of one embodiment of a hook shaped anchor. This type of hook shaped anchor allows a ring shaped terminal end or an end of a double loop shaped connector to be snapped into the hook. If the hook is sufficiently flexible, the terminal end may be repeatedly snapped into and out of the hook.

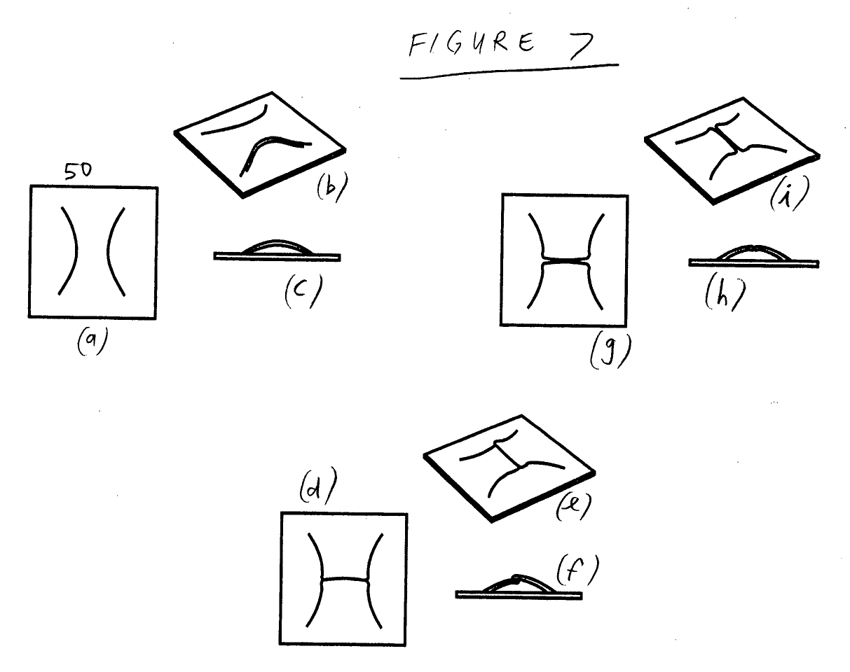

FIG. 7 shows several embodiments of anchors. Views (a) through (c) show a first embodiment of an anchor pad 50. FIG. 7 view (c) shows that there is no break in the upper region of this embodiment of the anchor pad 50. Views (d) through (f) show a second embodiment of an anchor pad 50. View (f) shows that there is a break in the upper region of this embodiment of the anchor pad 50, and shows the right upper portion overlapping the left upper portion. Views (g) through (i) show a third embodiment of an anchor pad 50, wherein there is a break in the upper region, and wherein the right upper portion and the left upper portion do not overlap. Other means of attachment include: snap, hook, loop, spring clamp, split ring, pressure lock, or other attachment means known in the art.

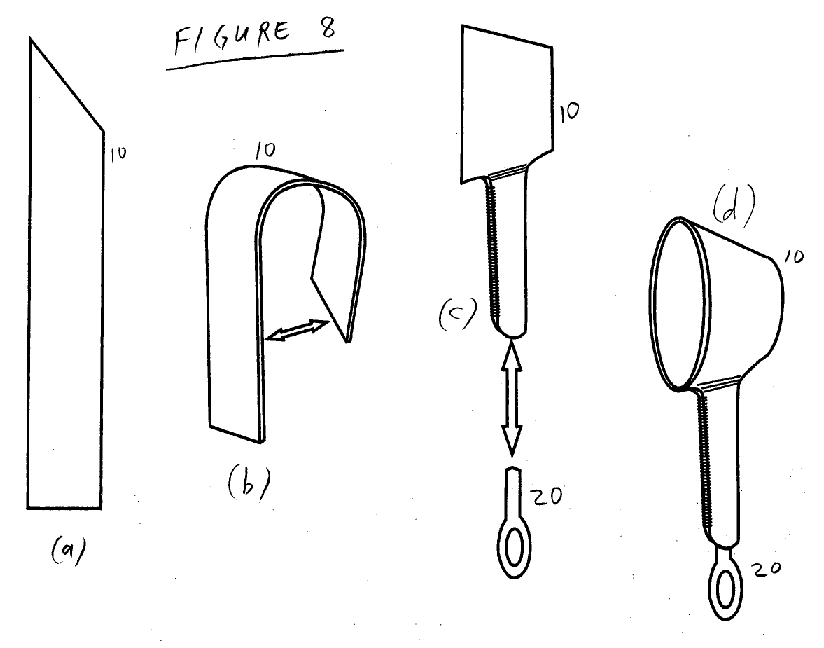

FIG. 8 shows an embodiment of a ring element created from a single strip of fabric and joined to a receiver. FIG. 8 view (a) shows a flat strip of resilient material for constructing the ring element 10. View (b) shows the flat strip being formed into the ring element 10 , by attaching the end of the strip to the body of the strip at an approximate 45 degree angle, by such methods including glue, sewing and fusing. View (c) shows the ring element 10, with a portion of the flat strip sewn into a shape adapted to accept a receiver 20. View (d) shows a ring element 10 with a receiver 20 glued, sewn, or fused into position. Receiver 20 in this embodiment may also function as a terminal end 40 for direct attachment to an anchor pad or direct attachment to device.

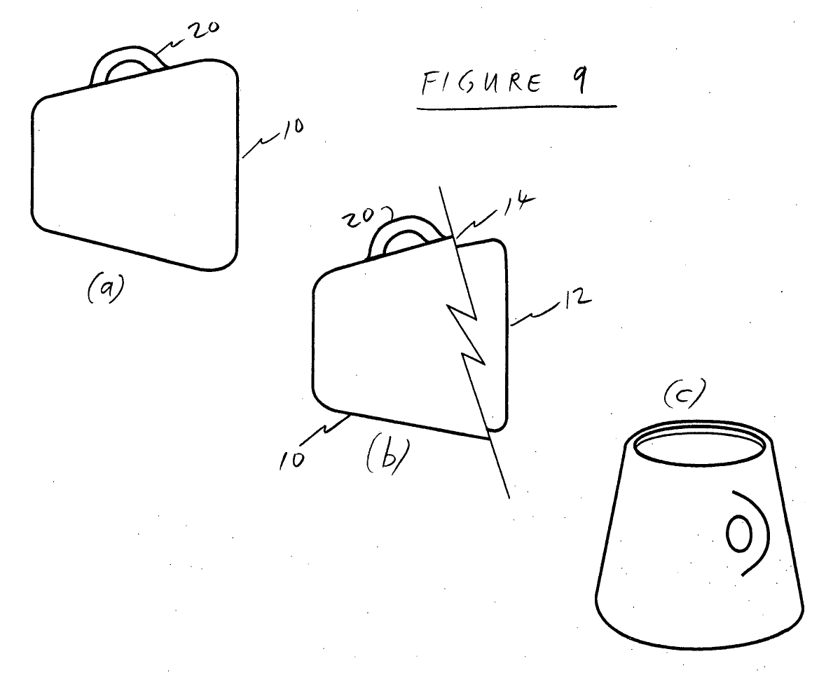

FIG. 9 shows an embodiment of a ring element with an internal element, and external shell, and with an integral external receiver. FIG. 9 view (a) shows a ring element 10 with an integrally formed external receiver 20, which may be formed from a single mold. View (b) shows a ring element 10 comprising a resilient plush inner liner or interior finish 12 applied to the interior of the ring element 10, and the external shell 14, and an integral external receiver 20. A portion of external shell 14 has been cut away to reveal the inner liner 12. The external shell 14 may be rubber, silicone, foam or other resilient manmade materials. Textures, figures, relief's, symbols and other adornments may be on the surface of external shell 14. The inner liner 12 may be a plush material such as nylon, velvet, leather and other materials providing flexibility and comfort. View (c) provides an additional detailed view.

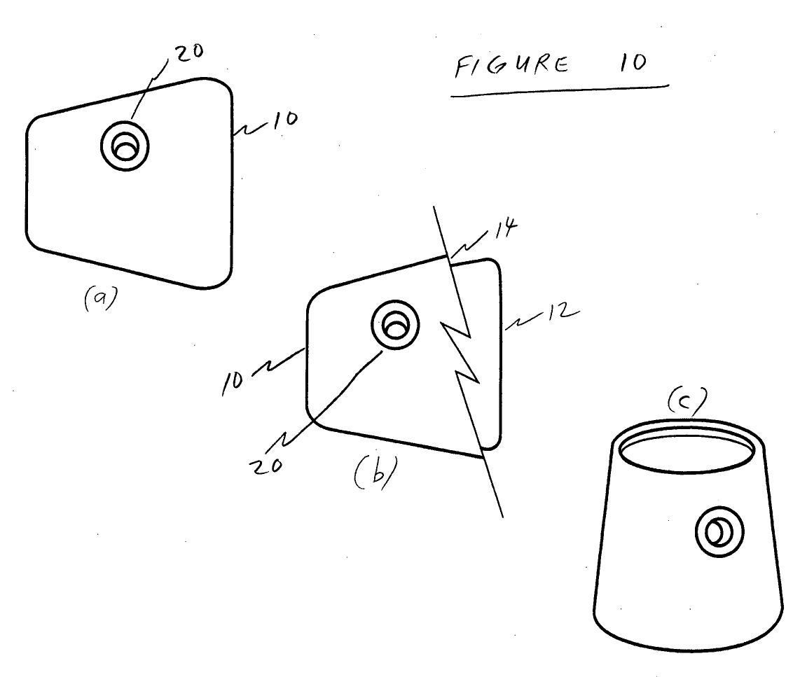

FIG. 10 shows an embodiment of a ring element with an internal element, and external shell, and with an integral internal receiver. FIG. 10 view (a) shows a ring element 10 with an integral internal receiver 20, which may be formed from a single mold. View (b) shows a ring element 10 (comprising a resilient inner liner 12 and a rigid or less resilient external shell 14), and an integral internal receiver 20. A portion of external shell 14 has been cut away to reveal the inner liner 12. The inner liner 12 may be neoprene, rubber, foam, or some other compressible resilient material providing flexibility and comfort. The external shell 14 may be a man made or natural material such as rigid plastic, nonstretch vinyl and leather, etc. and may be relatively stiff or non resilient. Textures, figures, relief's, symbols and other adornments may be on the surface of external shell 14. View (c) provides an additional detailed view.

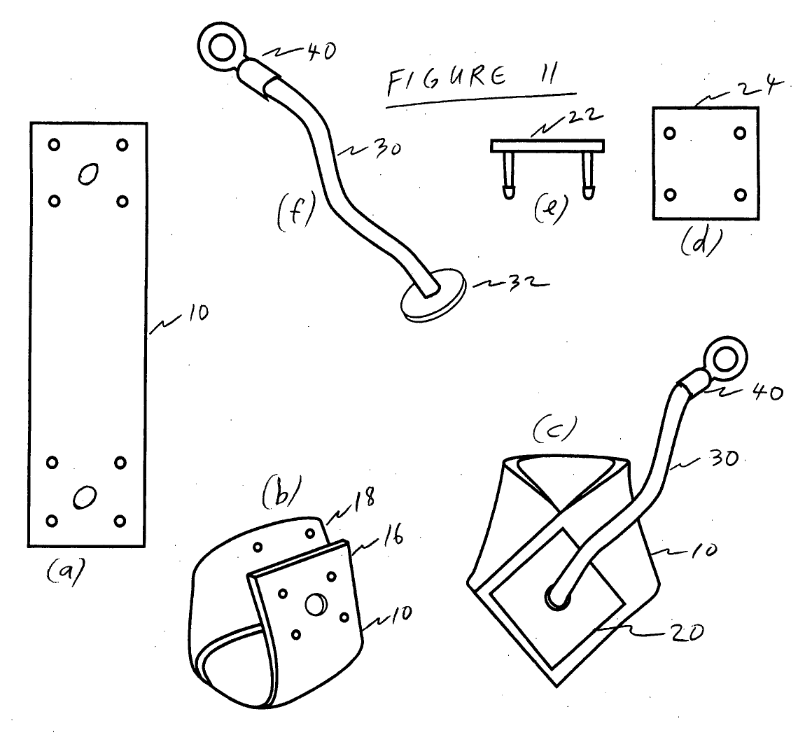

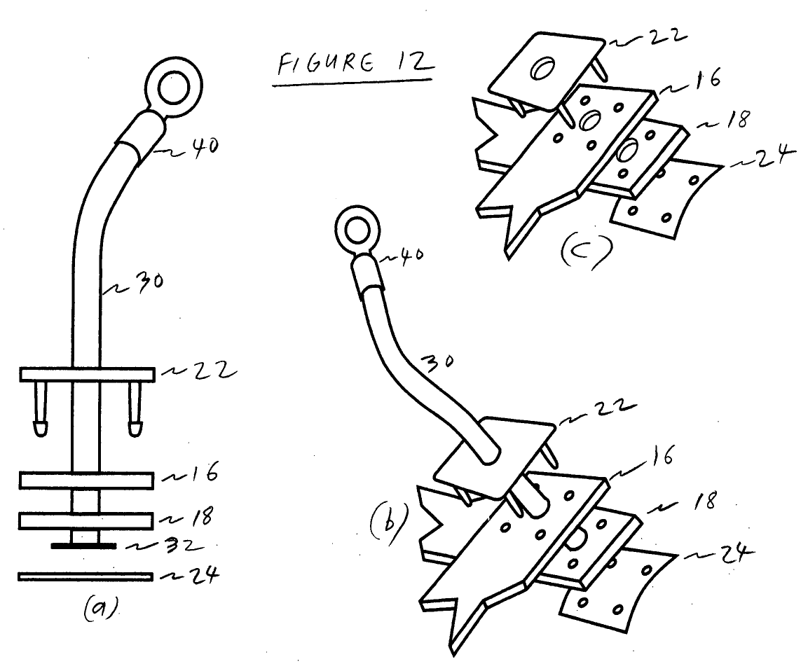

FIG. 11 shows an embodiment comprising a rectangular flat strip formed into a ring element. FIG. 11 view (a) shows a rectangular flat strip to be formed into a ring element 10. View (b) shows the rectangular flat strip being formed into a ring element 10 by overlapping the exterior flap 16 over the interior flap 18 approximately perpendicularly. View (f) shows a connector 30 with a terminal end 40 and a disk shaped end 32, wherein the disk shaped end 32 will be trapped inside of the receiver 20. View (e) shows a male portion 22 of receiver 20. View (d) shows a female portion 24 of receiver 20. Said male portion 22 is adapted to penetrate into and lockably snap into said female portion 24. View (c) shows the assembled portions from views (b), (d), (e), and (f). FIG. 12 below provides additional views of this embodiment, which will show a hole through the center of male portion 22. The male and female portions of the receiver 20 may be flat as shown by View (e) and View (d) or curved as shown in later embodiments.

FIG. 12 shows more views of an embodiment comprising a rectangular flat strip formed into a ring element. FIG. 12 view (a) shows a side view of the embodiment of FIG. 11 discussed above. From top to bottom, view (a) shows a terminal end 40, connector 30, male portion 22 of receiver 20, exterior flap 16 of ring element 10, interior flap 18 of ring element 10, disk shaped end 32 of connector 30, and female portion 24 of receiver 20. In this embodiment, the female portion 24 of receiver 20 will be directly against the skin of a user's finger. View (b) is a different view of the same embodiment, which more clearly shows the orientation of the exterior flap 16 of ring element 10 as approximately perpendicular to the interior flap 18 of ring element 10. Alternate orientations of the flaps may yield different angles of the conical shape of the ring element 10. A parallel orientation of the flaps will yield a cylindrical shape ring element 10. Alternate embodiments may include placing the male portion 22 interior to the female portion 24. View (c) shows male portion 22, exterior flap 16, interior flap 18, and female portion 24. Male portion 22 displays a hole through the center which is not visible in FIG. 11. The male portion 22 and female portion 24 of the receiver 20 may be flat as shown by View (a), or curved as shown by View (c) and View (b). The embodiment of FIG. 12 may be sold as a kit for the user to assemble by snapping the elements together.

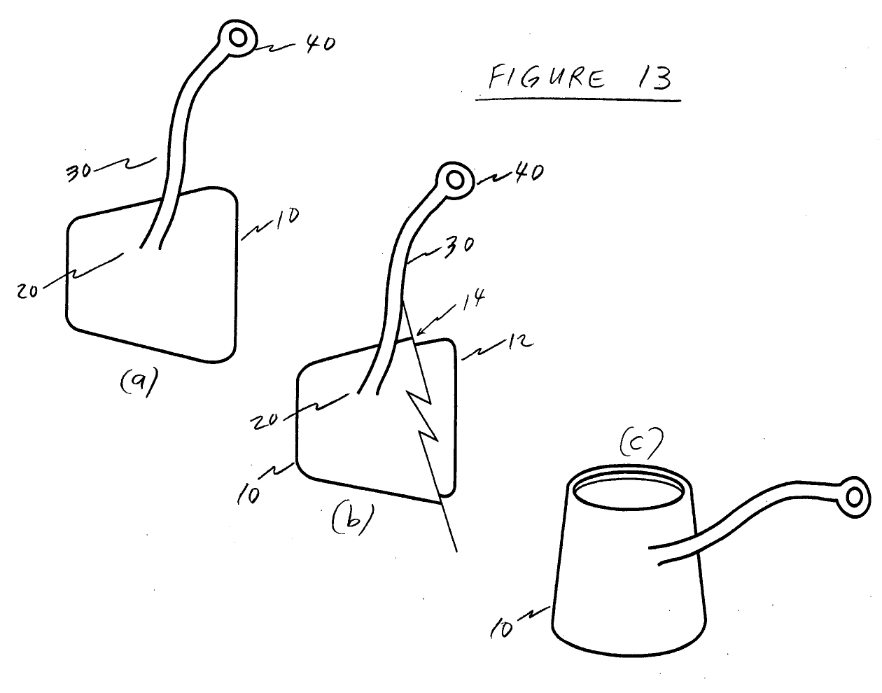

FIG. 13 shows a ring element with integral receiver, connector, and terminal end. FIG. 13 view (a) shows a ring element 10 with integral receiver 20, integral connector 30, and integral terminal end 40, which may be formed from a single mold. View (b) shows a ring element 10 (comprising a resilient inner liner 12 and a less resilient external shell 14), and an integral receiver 20, an integral connector 30, and an integral terminal end 40. A portion of external shell 14 has been cut away to reveal the inner liner 12. The external shell 14 may be rubber, silicone, foam or resilient manmade materials, and may be relatively stiff. Textures, figures, reliefs, symbols and other adornments may be on the surface of external shell 14. The inner liner 12 may be neoprene, or leather, or plush velvet, or may be soft vinyl, or may be other materials providing flexibility and comfort. View (c) provides an additional detailed view.

It is to be understood that the aforementioned description is illustrative only and that changes can be made in the invention, in the ingredients and their proportions and in the sequence of combination and process steps, as well as in other aspects herein without departing from the scope of the invention as defined in the following claims.

1. A ring system for securing devices, comprising:
a substantially conical ring element.

2. The ring system of claim 1, wherein the conical ring element is formed from a single piece of flat, resilient material.

3. The ring system of claim 1, further comprising:
a receiver;
a connector; and
a terminal end.

4. The ring system of claim 3, wherein the conical ring element, the receiver, the connector, and the terminal end are all integrally formed from a single casting or mold.

5. The ring system of claim 3, wherein the terminal end is adapted to repeatedly attach to or detach from an anchor.

6. The ring system of claim 3, wherein the conical ring element, the receiver, the connector, and the terminal end are not fully assembled.

7. The ring system of claim 6, wherein the conical ring element is a flat rectangular strip of resilient material before full assembly, and wherein the receiver comprises at least two portions adapted to snap together and attach the connector to the conical ring element.

8. The ring system of claim 3, wherein the conical ring element comprises a relatively non-resilient exterior shell and a relatively resilient interior lining.

9. The ring system of claim 3, further comprising:
an anchor.

10. The ring system of claim 9, wherein anchor comprises: an adhesive adapted to adhere to a device, and a non-stick covering adapted to protect the adhesive.

11. The ring system of claim 9, wherein the conical ring element, the receiver, the connector, the terminal end, and the anchor are all integrally formed from a single casting or mold.

12. A ring system for securing devices, comprising:
a substantially conical ring element formed from a resilient material, and sized to snugly surround a human finger;
a receiver comprising a non-resiliant material, and attached to the conical ring element;
a connector that is flexible and is attached to the receiver;
a terminal end attached to the connector
an anchor adapted to receive the terminal end, and comprising adhesive material adapted to adhere to a device.

13. The ring system of claim 12, wherein the terminal end is adapted to repeatedly detach from the anchor, and re-attach to the anchor.

14. The ring system of claim 12, wherein the substantially conical ring element has an internal conical angle of over 10 degrees and less than 20 degrees.

15. The ring system of claim 12, wherein the substantially conical ring element has an internal conical angle of over 20 degrees and less than 30 degrees.

16. The ring system of claim 12, wherein the substantially conical ring element has an internal conical angle of at least 30 degrees and less than 40 degrees.

17. The ring system of claim 12, wherein the substantially conical ring element has an internal conical angle of at least 40 degrees and less than 50 degrees.

18. The ring system of claim 12, wherein the substantially conical ring element has an internal conical angel of at least 50 degrees and less than 60 degrees.

19. A ring system for securing devices, comprising:
a ring element formed from a resilient material, and sized to snugly surround a human finger;
a receiver comprising a non-resiliant material, and attached to the ring element;
a connector that is flexible and is attached to the receiver;
a terminal end attached to the connector
an anchor adapted to receive the terminal end, and comprising adhesive material adapted to adhere to a device.

20. The ring system of claim 19, wherein the terminal end is adapted to repeatedly detach from the anchor, and re-attach to the anchor.

21. The ring system of claim 19 wherein the ring element, the receiver, the connector, and the terminal end are all integrally formed from a single casting or mold.

22. The ring system of claim 19 wherein the ring element, the receiver, the connector, the terminal end and the anchor are all integrally formed from a single casting or mold.

23. The ring system of claim 19 wherein the ring element, the receiver, the connector, the terminal end and the anchor are not fully assembled.
